(19) United States
(12) Patent Application Publication
(10) Pub. No.: US 2024/0091900 A1
(43) Pub. Date: Mar. 21, 2024

(54) POLISHING APPARATUS AND POLISHING METHOD

(71) Applicant: DISCO CORPORATION, Tokyo (JP)

(72) Inventors: Shun NAKAGAWA, Tokyo (JP); Yuki INOUE, Tokyo (JP)

(21) Appl. No.: 18/457,052

(22) Filed: Aug. 28, 2023

(30) Foreign Application Priority Data
Sep. 19, 2022 (JP) 2022-148658

(51) Int. Cl. B24B 37/14; B24B 37/04

(52) U.S. Cl. CPC B24B 37/14; B24B 37/044

(57) ABSTRACT

A polishing apparatus includes a holding table for holding a workpiece thereon, a polishing head disposed above the holding table and having an acrylic plate for polishing the workpiece held on the holding table, a moving mechanism for moving the polishing head toward the workpiece held on the holding table, and a polishing water supplying unit for supplying polishing water between the acrylic plate and the workpiece held on the holding table.

### BACKGROUND OF THE INVENTION

### Field of the Invention

The present invention relates to a polishing apparatus and a polishing method for polishing a workpiece that contains silicon in a surface thereof that is to be polished.

### Description of the Related Art

Heretofore, chemical mechanical polishing (CMP) apparatuses as disclosed in Japanese Patent Laid-open No. 2022-026348 and Japanese Patent Laid-open No. 2020-070380 have widely been used in the art to polish silicon wafers and glass plates. These CMP apparatuses polish a workpiece by mounting the workpiece on a polishing head disposed above a polishing pad and pressing the workpiece mounted on the polishing head against the polishing pad.

In polishing the workpiece, the polishing pad is supplied with a polishing liquid referred to as a slurry including an acid or alkaline aqueous solution mixed with minute abrasive grains of alumina, silica, zirconia, or the like.

### SUMMARY OF THE INVENTION

Generally, the slurry is expensive and makes the operating cost of the polishing apparatus high. If the slurry that has been used is abandoned unprocessed, then it adds to the environmental footprint. One solution would be to retrieve the used slurry for reuse, but would require a dedicated apparatus for slurry reproduction and a slurry reproducing process. The dedicated apparatus for slurry reproduction and the slurry reproducing process in addition to the polishing apparatus would make the whole polishing process complex.

It has been customary to retrieve the used slurry, aggregate and separate minute abrasive grains from the slurry with processing water, drain the processing water away, and incinerate the aggregated and separated sludge for disposal. However, the process still increases the environmental footprint, and the cost of discarding the waste is high.

It is therefore an object of the present invention to provide a polishing apparatus and a polishing method that do not use the polishing liquid that has heretofore been used in the art.

In accordance with an aspect of the present invention, there is provided a polishing apparatus including a holding table for holding a workpiece thereon, a polishing head disposed above the holding table and having an acrylic plate for polishing the workpiece held on the holding table, a moving mechanism for moving the polishing head toward the workpiece held on the holding table, and a polishing water supplying unit for supplying polishing water between the acrylic plate and the workpiece held on the holding table.

Preferably, in the polishing apparatus, the workpiece has a surface to be polished by the acrylic plate, the surface containing silicon, or the workpiece has a surface to be polished by the acrylic plate, the surface being made of glass.

In accordance with another aspect of the present invention, there is provided a polishing method including a holding step of holding a workpiece on a holding table, and after the holding step has been carried out, a polishing step of bringing an acrylic plate of a polishing head disposed above the holding table into contact with the workpiece held on the holding table and polishing the workpiece with the acrylic plate while supplying polishing water between the acrylic plate and the workpiece.

Preferably, in the polishing method, the workpiece has a surface to be polished by the acrylic plate, the surface containing silicon, or the workpiece has a surface to be polished by the acrylic plate, the surface being made of glass.

The polishing apparatus and the polishing method according to the present invention can alleviate the problems of the increased environmental footprint and the high cost of discarding the waste and can simplify the whole polishing process.

Furthermore, since the polishing head is disposed above the holding table for holding the workpiece thereon, the polishing water can efficiently be supplied between the acrylic plate and the workpiece, resulting in an increase in the rate at which the workpiece is processed, i.e., polished.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view illustrating an example of a processing apparatus that includes a polishing apparatus according to an embodiment of the present invention;

FIG. 2 is a perspective view illustrating an example of a wafer as a workpiece to be processed by the processing apparatus illustrated in FIG. 1;

FIG. 3 is a flowchart of the processing sequence of an example of a processing method according to the embodiment;

FIG. 4 is a side elevational view, partly in cross section, of a grinding step of the processing method illustrated in FIG. 3;

FIG. 5 is a side elevational view illustrating the manner in which a wafer is delivered to a holding table;

FIG. 6A is a cross-sectional view illustrating a holding step of the processing method illustrated in FIG. 3;

FIG. 6B is a cross-sectional view illustrating a polishing step of the processing method illustrated in FIG. 3;

FIG. 7A is a cross-sectional view illustrating the manner in which the wafer is polished by an acrylic plate that is substantially equal in diameter to the wafer and that is positioned in partly covering relation to the wafer according to another embodiment of the present invention;

FIG. 7B is a plan view illustrating the manner in which the wafer is polished by the acrylic plate illustrated in FIG. 7A;

FIG. 8A is a cross-sectional view illustrating the manner in which the wafer is polished by an acrylic plate that is smaller in diameter than the wafer and that is positioned within the range of the wafer according to still another embodiment of the present invention; and

FIG. 8B is a plan view illustrating the manner in which the wafer is polished by the acrylic plate illustrated in FIG. 8A.

### DETAILED DESCRIPTION OF THE PREFERRED EMBODIMENTS

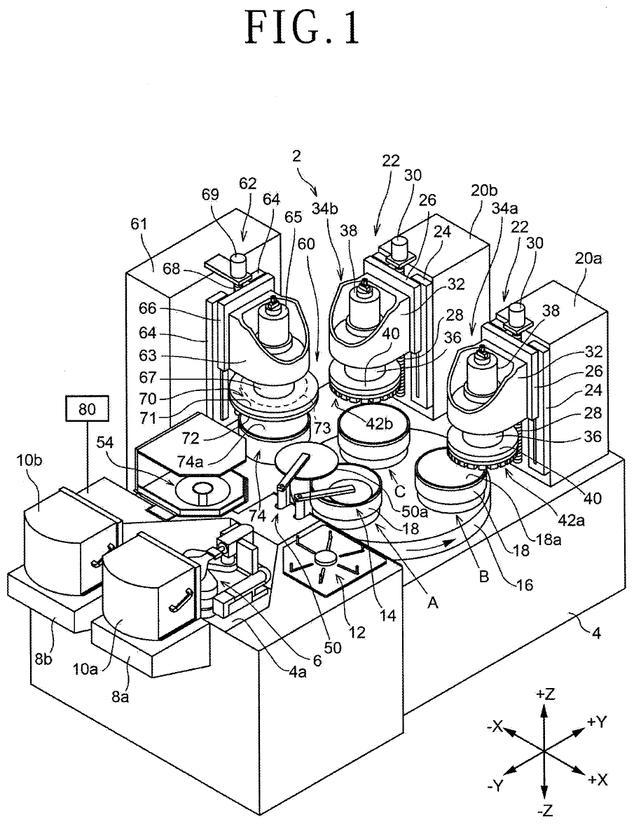

Preferred embodiments of the present invention will be described below with reference to the accompanying drawings. FIG. 1 illustrates in perspective an example of a processing apparatus 2 that includes a polishing apparatus according to an embodiment of the present invention. As illustrated in FIG. 1, the processing apparatus 2 includes a rough grinding unit 34a, a finishing grinding unit 34b, which are main components of a grinding apparatus, and a polishing unit 60, which is a main component of the polishing apparatus. The grinding apparatus with the rough grinding unit 34a and the finishing grinding unit 34b, and the polishing apparatus with the polishing unit 60 may be constructed as an independent apparatus and installed in line with each other.

For example, if the polishing apparatus is constructed as an independent apparatus, then the polishing unit 60 includes a polishing head 70, a holding table 74 for holding a workpiece thereon, the polishing head 70 having an acrylic plate 72 disposed above the holding table 74 for polishing the workpiece held on the holding table 74, a Z-axis moving mechanism 62 for moving the polishing head 70 toward the workpiece held on the holding table 74, and a polishing water supplying unit 73 for supplying polishing water between the acrylic plate 72 and the workpiece held on the holding table 74.

The processing apparatus 2 will be described in greater detail below with reference to FIG. 1. In FIG. 1, the processing apparatus 2 is illustrated in reference to a three-dimensional XYZ coordinate system including an X-axis, a Y-axis perpendicular to the X-axis, and a Z-axis perpendicular to the X-axis and the Y-axis. The X-axis extends horizontally and +X and −X directions indicated respectively by the arrows +X and −X extend along the X-axis. The Y-axis extends horizontally and +Y and −Y directions indicated respectively by the arrows +Y and −Y extend along the Y-axis. The Z-axis extends vertically and +Z and −Z directions indicated respectively by the arrows +Z and −Z extend along the Z-axis. As illustrated in FIG. 1, the processing apparatus 2 includes a base 4 substantially shaped as a rectangular parallelepiped. The base 4 has a longitudinal axis extending along the Y-axis and a heightwise, i.e., vertical, axis extending along the Z-axis. The processing apparatus 2 includes two cassette rest tables 8a and 8b mounted on an edge of the base 4 in one of the +Y and −Y directions, e.g., the −Y direction. The cassette rest tables 8a and 8b are juxtaposed along the X-axis.

Two cassettes 10a and 10b are placed respectively on the cassette rest tables 8a and 8b. One of the cassettes 10a stores a plurality of circular workpieces to be processed, whereas the other cassette 10b stores a plurality of workpieces that have been processed. Each of the workpieces stored in the cassette 10a includes, for example, a wafer to be ground on its face side or a wafer that has been ground which is to be polished on its reverse side. Each of the workpieces stored in the cassette 10b includes, for example, a wafer that has been ground and polished.

The base 4 has an upwardly open cavity 4a defined therein behind the cassette rest tables 8a and 8b in the +Y direction, for example. A delivery robot 6 for accessing the cassettes 10a and 10b etc. is housed in the cavity 4a. The delivery robot 6 includes, for example, a robot hand for holding a workpiece under suction and delivering the workpiece thus held.

A positioning table 12 having a plurality of movable pins is disposed on the base 4 on one side of the cavity 4a in one of the +X and −X directions, e.g., in the +X direction. A workpiece is unloaded from the cassette 10a onto the positioning table 12 by the delivery robot 6 and is positionally adjusted by the positioning pins of the positioning table 12.

A loading arm 14 is disposed on the base 4 on one side of the positioning table 12 in the other of the +X and −X directions, i.e., in the −X direction and on one side of the cavity 4a in the other of the directions +Y and −Y directions, i.e., in the +Y direction. The loading arm 14 has a suction delivery pad for holding a workpiece under suction thereon and delivering the workpiece thus held, for example.

A disk-shaped turntable 16 is disposed on the base 4 on one side of the loading arm 14 in the other of the directions +Y and −Y directions, i.e., in the +Y direction. The turntable 16 is rotatable about its central axis along the Z-axis. The turntable 16 supports thereon three circular holding tables 18 for holding respective workpieces thereon. The holding tables 18 are angularly spaced at intervals of approximately 120 degrees circumferentially around the central axis of the turntable 16. Each of the holding tables 18 is rotatable about its central axis along the Z-axis.

The holding tables 18 can be positioned respectively in three areas, i.e., a loading and unloading area A closest to the loading arm 14, a roughly grinding area B that is approximately 120 degrees spaced from the loading and unloading area A counterclockwise as viewed in plan, and a finishing grinding area C that is approximately 120 degrees spaced from the roughly grinding area B clockwise as viewed in plan.

When the turntable 16 is rotated about its central axis, the holding tables 18 move clockwise in the direction indicated by the arrow, each going successively to the loading and unloading area A, the roughly grinding area B, and the finishing grinding area C. For example, the holding table 18 that has been positioned in the loading and unloading area A rotates clockwise upon rotation of the turntable 16, going to the roughly grinding area B, then to the finishing grinding area C, and back to the loading and unloading area A.

Each of the holding tables 18 includes a porous plate made of a porous material in its upper end portion. The porous plate has an upper surface functioning as a holding surface 18a of the holding table 18. The holding surface 18a is of a slightly conical shape having its apex positioned at its central axis and an outer circumferential edge slightly lower than the apex. The holding surface 18a is fluidly connected to a suction source, not illustrated. When the suction source is actuated, it generates and transmits a suction force to the holding surface 18a, attracting a workpiece placed thereon under suction on the holding surface 18a while keeping the workpiece in a slightly conical shape on the holding surface 18a.

A workpiece whose reverse side is attracted under suction by the loading arm 14 is delivered thereby to the holding table 18 that is positioned in the loading and unloading area A. Thereafter, the loading arm 14 releases the workpiece of the suction attraction, whereupon the face side of the workpiece is held under suction on the holding surface 18a of the holding table 18.

A support structure 20a shaped as a square prism is disposed on the base 4 on one side of the turntable 16 in the other of the directions +Y and −Y directions, i.e., in the +Y direction and extends upwardly in one of the +Z and −Z directions, e.g., in the +Z direction. A Z-axis moving mechanism 22 is mounted on a side surface of the support structure 20a that faces in the one of the +Y and −Y directions, i.e., the −Y direction.

The Z-axis moving mechanism 22 includes a pair of Z-axis guide rails 24 disposed on the side surface of the support structure 20a and extending generally parallel to the Z-axis. A Z-axis movable plate 26 is slidably mounted on the Z-axis guide rails 24 for sliding movement therealong.

A nut, not illustrated, is mounted on a reverse side of the Z-axis movable plate 26 that faces the side surface of the support structure 20a. The nut is operatively threaded over a Z-axis ball screw 28 disposed between the Z-axis guide rails 24 and extending along the Z-axis guide rails 24.

The Z-axis ball screw 28 has an upper end coupled to a Z-axis stepping motor 30. When the Z-axis stepping motor 30 is energized, it rotates the Z-axis ball screw 28 about its central axis, moving the Z-axis movable plate 26 along the Z-axis guide rails 24.

A support member 32 is mounted on a face side of the Z-axis movable plate 26 that faces in the −Y direction. The support member 32 supports thereon the rough grinding unit 34a for roughly grinding a workpiece. The rough grinding unit 34a includes a tubular spindle housing fixed to the support member 32.

A spindle 36 is rotatably housed in the spindle housing for rotation about a rotational axis parallel to the Z-axis. The spindle 36 has an upper end coupled to a spindle motor 38.

The spindle 36 has a lower end portion exposed out of the spindle housing and having a lower end to which there is fixed an upper surface of a disk-shaped wheel mount 40 made of a metal material such as stainless steel. The rough grinding unit 34a includes a disk-shaped roughly grinding wheel 42a that is substantially equal in diameter to the wheel mount 40 and mounted on a lower surface of the wheel mount 40.

The roughly grinding wheel 42a has a substantially disk-shaped wheel base made of a metal material such as stainless steel and a plurality of grindstones mounted in an annular pattern on a lower surface of the wheel base remote from the wheel mount 40. The grindstones, each shaped as a substantially rectangular parallelepiped, are arrayed fully circumferentially around the lower surface of the wheel base with gaps between adjacent ones of the grindstones.

Each of the grindstones may be made of abrasive grains of diamond, cubic boron nitride (CBN), or the like mixed with a binder of metal, ceramic, resin, or the like. However, the abrasive grains and the binder are not limited to any particular materials and may be made of materials suitable for the specifications of the grindstones. The roughly grinding area B referred to above is positioned directly below the rough grinding unit 34a.

Another support structure 20b shaped as a square prism is disposed on the base 4 adjacent to the support structure 20a in the other of the +X and −X directions, i.e., in the −X direction. Another Z-axis moving mechanism 22 is mounted on a side surface of the support structure 20b that faces in the one of the +Y and −Y directions, i.e., the −Y direction, as with the support structure 20a.

The finishing grinding unit 34b is operatively coupled to the Z-axis moving mechanism 22 on the support structure 20b by a Z-axis movable plate 26 and a support member 32. The finishing grinding area C referred to above is positioned directly below the finishing grinding unit 34b. The finishing grinding unit 34b has a spindle 36, a spindle housing, a spindle motor 38, and a wheel mount 40, as with the rough grinding unit 34a.

The finishing grinding unit 34b includes a disk-shaped finishing grinding wheel 42b that is substantially equal in diameter to the wheel mount 40 and mounted on a lower surface of the wheel mount 40. The finishing grinding wheel 42b has a wheel base and a plurality of grindstones mounted in an annular pattern on a lower surface of the wheel base.

The grindstones, each shaped as a substantially rectangular parallelepiped, are arrayed fully circumferentially around the lower surface of the wheel base with gaps between adjacent ones of the grindstones. Each of the grindstones is made of abrasive grains mixed with a binder. The abrasive grains of the grindstones of the finishing grinding wheel 42b are smaller than the abrasive grains of the grindstones of the roughly grinding wheel 42a.

The reverse side of a workpiece is ground successively by the rough grinding unit 34a and the finishing grinding unit 34b. For example, the rough grinding unit 34a roughly grinds the workpiece while the spindle is rotating at a first spindle speed and the rough grinding unit 34a is being incising-fed, i.e., lowered, at a first incising feed speed along the Z-axis, and the finishing grinding unit 34b finishingly grinds the workpiece while the spindle is rotating at a second spindle speed and the finishing grinding unit 34b is being incising-fed, i.e., lowered, at a second incising feed speed along the Z-axis. The first and second spindle speeds and the first and second incising feed speeds do not need to be of a constant value all times.

Still another support structure 61 shaped as a rectangular prism is disposed on the base 4 on one side of the support structure 20b in the one of the +Y and −Y directions, i.e., the −Y direction. A Z-axis moving mechanism 62 is mounted on a side surface of the support structure 61 that faces in the one of the +X and −X directions, i.e., in the +X direction.

The Z-axis moving mechanism 62 includes a pair of Z-axis guide rails 64 disposed on the side surface of the support structure 61 and extending generally parallel to the Z-axis. A Z-axis movable plate 66 is slidably mounted on the Z-axis guide rails 64 for sliding movement therealong.

A nut, not illustrated, is mounted on a reverse side of the Z-axis movable plate 66 that faces the side surface of the support structure 61. The nut is operatively threaded over a Z-axis ball screw 68 disposed between the Z-axis guide rails 64 and extending along the Z-axis guide rails 64.

The Z-axis ball screw 68 has an upper end coupled to a Z-axis stepping motor 69. When the Z-axis stepping motor 69 is energized, it rotates the Z-axis ball screw 68 about its central axis, moving the Z-axis movable plate 66 along the Z-axis guide rails 64.

A support member 63 is mounted on a face side of the Z-axis movable plate 66 that faces in the +X direction. The support member 63 supports thereon the polishing unit 60 for polishing a workpiece. The polishing unit 60 includes a tubular spindle housing fixed to the support member 63.

A spindle 67 is rotatably housed in the spindle housing for rotation about a rotational axis parallel to the Z-axis. The spindle 67 has an upper end coupled to a spindle motor 65.

The spindle 67 has a lower end portion exposed out of the spindle housing and having a lower end to which there is fixed a polishing head 67. The polishing head 67 includes a disk-shaped wheel mount 71 made of a metal material such as stainless steel and the disk-shaped acrylic plate 72 fixed to a lower surface of the wheel mount 71.

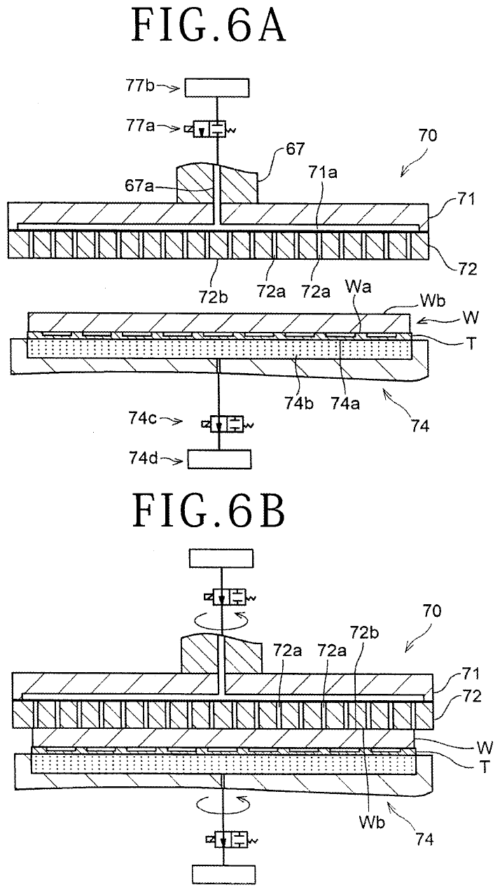

The holding table 74 is disposed directly below the polishing head 70. The holding table 74 includes a holding plate 74b (see FIG. 6A) as a porous plate made of a porous material in its upper end portion. The porous plate has an upper surface functioning as a holding surface 74a of the holding table 74. The holding surface 74a is commensurate in size with the wafer W. The holding surface 74a includes a flat surface and is fluidly connected to a suction source 74d through a control valve 74c. When the suction source 74d is actuated and the control valve 74c is opened, the suction source 74d generates and transmits a suction force to the holding surface 74a, attracting a workpiece placed thereon under suction on the holding surface 74a while keeping the circular upper surface of the workpiece in a flat shape on the holding surface 74a.

An unloading arm 50 is disposed on the base 4 on one side of the loading arm 14 in the other of the +X and −X directions, i.e., in the −X direction. The unloading arm 50 has a suction delivery pad for holding a workpiece under suction thereon and delivering the workpiece thus held, for example.

The unloading arm 50 unloads a workpiece that has been finishingly ground from the holding table 18 positioned in the loading and unloading area A onto the holding table 74 below the polishing head 70. The unloading arm 50 also unloads a workpiece that has been polished, from the holding table 74 to a spinner cleaning unit 54.

The spinner cleaning unit 54 includes a spinner table rotatable at a high speed while holding a workpiece thereon, a cleaning chamber that houses the spinner table therein, and a spinner cover covering the cleaning chamber. The spinner cover is automatically opened and closed when a workpiece is loaded into and unloaded from the cleaning chamber. A workpiece that has been cleaned by the spinner cleaning unit 54 is unloaded from the spinner cleaning unit 54 into the cassette 10b by the delivery robot 6.

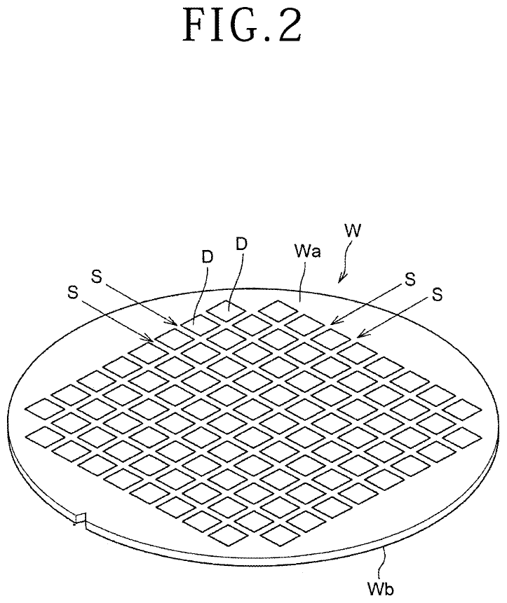

FIG. 2 illustrates in perspective a wafer W as an example of a workpiece. For example, the wafer W is constructed as a semiconductor wafer having a plurality of devices D such as integrated circuits (ICs) or large-scale integration (LSI) circuits in a surface of a disk-shaped substrate made of silicon or a compound containing silicon. The wafer W has a reverse side Wb to be polished.

The wafer W has a face side Wa including a plurality of areas demarcated by a grid of projected dicing lines S established thereon, with the devices D disposed respectively in the areas. However, the face side Wa of the wafer W may be free of the devices D. The wafer W may be a wafer of glass rather than a semiconductor wafer.

The workpiece to be polished by the polishing apparatus according to the present embodiment has a surface to be polished that is made of silicon, a compound containing silicon, glass, or the like. The surface to be polished of the workpiece is polished by an acrylic plate, as described later. The substrate of the wafer W may be made in its entirety of silicon, a compound containing silicon, glass, or the like. Alternatively, only the surface to be polished of the workpiece may be made of silicon, a compound containing silicon, glass, or the like. For example, the workpiece may include a substrate of silicon and a silicon layer disposed on the substrate. Furthermore, the workpiece may contain silicon (Si) in the surface to be polished, which may be combined with carboxylic acid when it is polished by the acrylic plate.

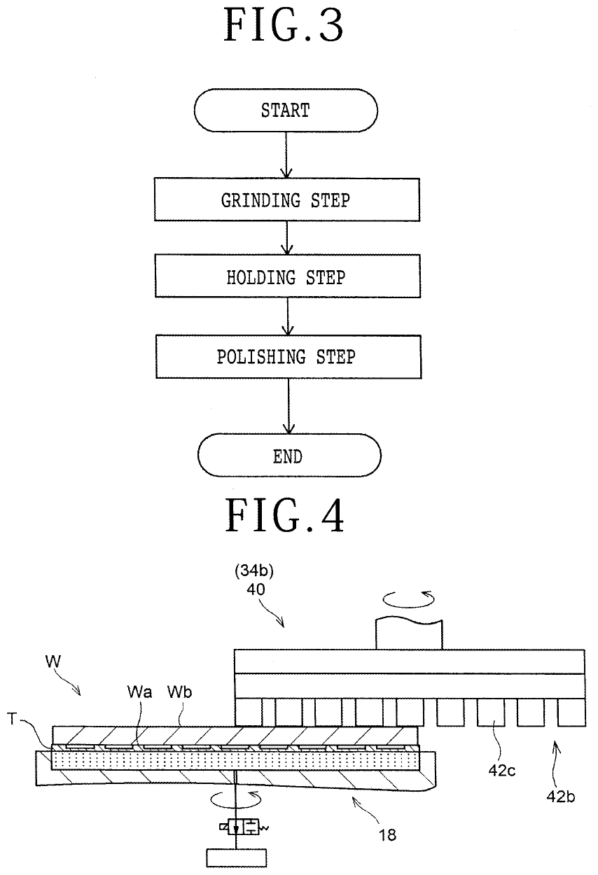

A processing method to be carried out by the processing apparatus 2 illustrated in FIG. 1 will be described below by way of example. FIG. 3 is a flowchart of the processing sequence of an example of the processing method according to the embodiment. As illustrated in FIG. 3, the processing method includes a grinding step, a holding step, and a polishing step. Although the processing method illustrated in FIG. 3 includes the grinding step, the grinding step may not be carried out depending on the nature of a workpiece to be processed.

### <Grinding Step>

As illustrated in FIG. 4, the reverse side Wb of the wafer W is successively roughly ground and finishingly ground respectively by the rough grinding unit 34a (see FIG. 1) and the finishing grinding unit 34b (see FIG. 1). In FIG. 4, the wheel mount 40 of the finishing grinding unit 34b is illustrated above the holding table 18 that is holding under suction the face side Wa of the wafer W with a surface protecting tape T interposed therebetween.

While the holding table 18 is being rotated about its central axis, the wheel mount 40 as it is rotated about its central axis is lowered to cause the grindstones 42c of the finishing grinding wheel 42b to finishingly grind the reverse side Wb of the wafer W. When the rough grinding unit 34a and the finishing grinding unit 34b grind respective wafers W, pure water is supplied as grinding wafer to the wafer W from grinding water supply channels defined in the roughly grinding wheel 42a and the finishing grinding wheel 42b or from external nozzles.

### <Holding Step>

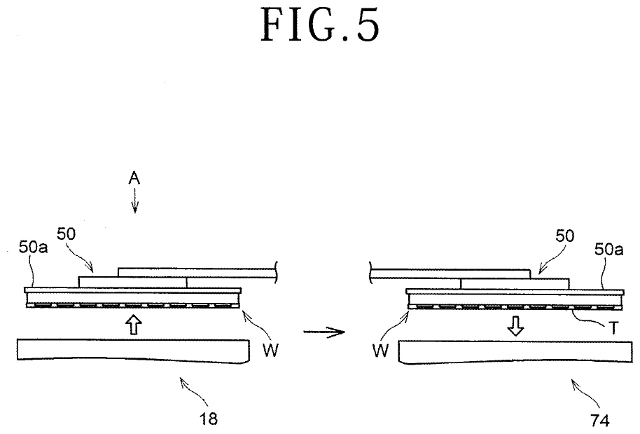

The holding step is a step of holding the wafer W on the holding table 74 below the polishing unit 60, as illustrated in FIG. 5.

Specifically, the wafer W that has been finishingly ground by the finishing grinding unit 34b (see FIG. 1) is held on the holding table 18 positioned in the loading and unloading area A. Thereafter, the exposed upper surface Wb of the wafer W on the holding table 18 positioned in the loading and unloading area A is held under suction by the suction delivery pad, denoted by 50a in FIG. 5, of the unloading arm 50. After the wafer W has been unloaded from the holding table 18 positioned in the loading and unloading area A by the unloading arm 50, the unloading arm 50 is turned to load the wafer W onto the holding table 74 below the polishing unit 60. The face side Wa of the wafer W is then held on the holding surface 74a of the holding table 74 with the surface protecting tape T interposed therebetween.

While the wafer W is thus being delivered from the holding table 18 to the holding table 74, the wafer W is not turned upside down. Since the reverse side Wb of the wafer W that has been finishingly ground and the reverse side Wb of the wafer W that is to be polished face upwardly, the wafer W can easily and stably be delivered from the finishing grinding unit 34b to the polishing unit 60 and hence is less liable to be damaged while being thus delivered.

As illustrated in FIG. 6A, inasmuch as the reverse side Wb of the wafer W whose face side Wa is held on the holding surface 74a of the holding table 74 is exposed upwardly, the exposed reverse side Wb of the wafer W can be ground by the acrylic plate 72 of the polishing head 70 disposed above the holding table 74. As the holding surface 74a is commensurate in size with the wafer W, the face side Wa of the wafer W is held in its entirety on the holding surface 74a.

As described above, when the suction source 74d is actuated and the control valve 74c is opened, the suction force generated by the suction source 74d is transmitted through the control valve 74c to the holding surface 74a, which holds the face side Wa of the wafer W under suction thereon with the surface protecting tape T interposed therebetween.

### <Polishing Step>

As illustrated in FIGS. 6A and 6B, the polishing step is a step of bringing the acrylic plate 72 of the polishing head 70 disposed above the holding table 74 into contact with the exposed reverse side Wb of the wafer W and polishing the wafer W with a lower surface 72b of the acrylic plate 72 while polishing water is being supplied between the acrylic plate 72 and the wafer W.

The wafer W has a diameter of 8 inches, for example. As illustrated in FIG. 6A, the acrylic plate 72 has a diameter larger than the diameter of the wafer W. Therefore, the lower surface 72b of the acrylic plate 72 can fully cover the reverse side Wb of the wafer W in its entirety.

As described above, the polishing head 70 of the polishing unit 60 is fixed to the lower end of the spindle 67, and the polishing head 70 includes the disk-shaped wheel mount 71 made of a metal material such as stainless steel and the disk-shaped acrylic plate 72 fixed to the lower surface of the wheel mount 71.

The wheel mount 71 has a polishing water supply channel 71a defined in the lower surface thereof for supplying polishing water. The polishing water supply channel 71a, which functions as the polishing water supplying unit 73 referred to above, is fluidly connected to a polishing water supply source 77b through a supply channel 67a defined in the spindle 67 and a control valve 77a. The polishing water includes pure water, for example.

The disk-shaped acrylic plate 72 fixed to the lower surface of the wheel mount 71 has a plurality of polishing water supply ports 72a defined therein that extend thicknesswise through the acrylic plate 72.

The polishing water supply ports 72a have upper openings held in fluid communication with the polishing water supply channel 71a and lower openings that are open at the lower surface 72b of the acrylic plate 72. When the polishing water supply source 77b is actuated and the control valve 77a is opened, the polishing water supplied from the polishing water supply source 77b flows through the control valve 77a, the supply channel 67a, the polishing water supply channel 71a, and the polishing water supply ports 72a to the lower surface 72b of the acrylic plate 72.

The polishing unit 60 polishes the wafer W on the holding table 74 as follows. While the polishing water is being supplied through the polishing water supply ports 72a between the acrylic plate 72 and the wafer W, the holding table 74 is rotated about its central axis at a speed ranging from 700 to 750 rpm, and the lower surface 72b of the acrylic plate 72 is abrasively pressed against the reverse side Wb of the wafer W.

The acrylic plate 72 is freely rotatable with respect to the wheel mount 71, so that the acrylic plate 72 polishes the wafer W while corotating with the wafer W. Alternatively, the acrylic plate 72 may be positively rotatable at a predetermined speed or may be both freely rotatable and positively rotatable at a predetermined speed while polishing the wafer W.

When the acrylic plate 72 polishes the wafer W, the pure water supplied as the polishing water decomposes the ester group of the acrylic plate 72 into carboxylic acid and alcohol, and the carboxylic acid is combined with silicon contained in the wafer W, removing minute convexities from the reverse side Wb of the wafer W and hence planarizing the reverse side Wb.

Since the acrylic plate 72 of the polishing head 70 is disposed above the wafer W held on the holding table 74, the polishing water is efficiently supplied by gravity to the wafer W downwardly through the polishing water supply ports 72a defined extending thicknesswise through the acrylic plate 72, resulting in an increase in the rate at which the wafer W is processed, i.e., polished. Furthermore, as the polishing water that has been used in polishing the wafer W flows radially outwardly off the wafer W, the polishing water is efficiently drained without re-entry between the acrylic plate 72 and the wafer W.

The polishing water supplying unit 73 illustrated in FIG. 1 supplies polishing water between the acrylic plate 72 and the wafer W from an external nozzle, not illustrated, disposed outside of the polishing head 70, in addition to the polishing water supplied between the acrylic plate 72 and the wafer W from the polishing water supply ports 72a.

As illustrated in FIGS. 6A and 6B, the acrylic plate 72 is larger in diameter than the wafer W and has its center aligned with the center of the wafer W. Therefore, the acrylic plate 74 polishes the reverse side Wb of the wafer W in its entirety while fully covering the reverse side Wb.

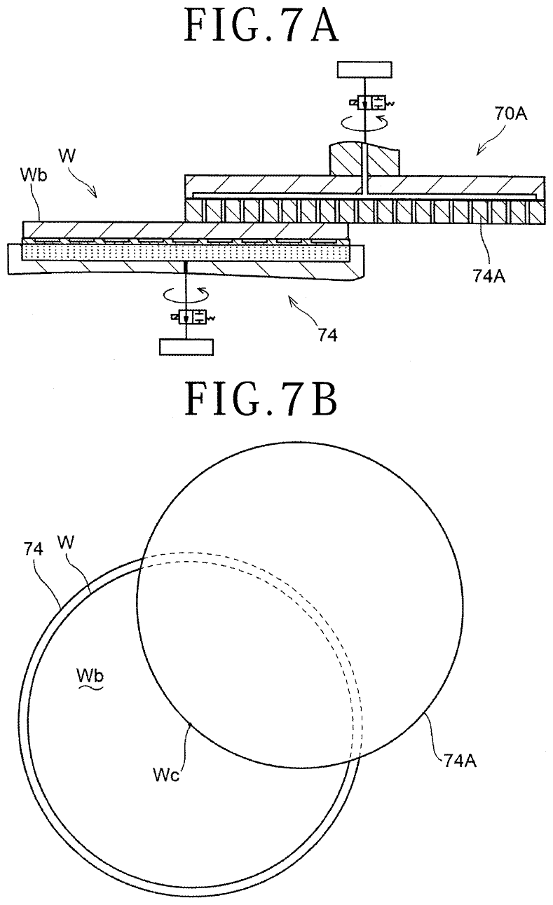

According to another embodiment illustrated in FIGS. 7A and 7B, an acrylic plate 74A is substantially equal in diameter to the wafer W and has an outer circumferential edge positioned across the center, denoted by We in FIG. 7B, of the wafer W. Therefore, the acrylic plate 74A polishes the reverse side Wb of the wafer W while partly covering the reverse side Wb.

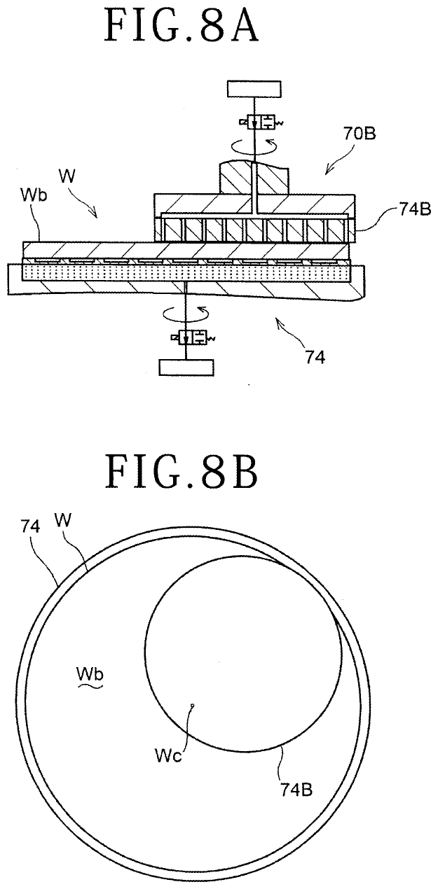

According to still another embodiment illustrated in FIGS. 8A and 8B, an acrylic plate 74B is smaller in diameter than the wafer W and is abrasively pressed against the reverse side Wb of the wafer W within the range of the wafer W, i.e., without protruding radially outwardly from the outer circumferential edge of the wafer W. According to the present embodiment, since the acrylic plate 74B is smaller in diameter than the wafer W and hence has a relatively small area with respect to the wafer W, the acrylic plate 74B has its upper and lower surfaces planarized with ease. Consequently, the acrylic plate 74B can planarize the wafer W to a higher degree by polishing it.

According to the embodiments described above, it is possible to polish workpieces with pure water, not the expensive slurry that has been used heretofore. Therefore, the polishing apparatus and the polishing method according to the present invention can alleviate the problems of the increased environmental footprint and the high cost of discarding the waste and can simplify the whole polishing process.

The present invention is not limited to the details of the above-described preferred embodiments. The scope of the invention is defined by the appended claims and all changes and modifications as fall within the equivalence of the scope of the claims are therefore to be embraced by the invention.

What is claimed is:

1. A polishing apparatus comprising:
a holding table for holding a workpiece thereon;
a polishing head disposed above the holding table and having an acrylic plate for polishing the workpiece held on the holding table;
a moving mechanism for moving the polishing head toward the workpiece held on the holding table; and
a polishing water supplying unit for supplying polishing water between the acrylic plate and the workpiece held on the holding table.

2. The polishing apparatus according to claim 1, wherein the workpiece has a surface to be polished by the acrylic plate, the surface containing silicon.

3. The polishing apparatus according to claim 1, wherein the workpiece has a surface to be polished by the acrylic plate, the surface being made of glass.

4. A polishing method comprising:
a holding step of holding a workpiece on a holding table; and
after the holding step has been carried out, a polishing step of bringing an acrylic plate of a polishing head disposed above the holding table into contact with the workpiece held on the holding table and polishing the workpiece with the acrylic plate while supplying polishing water between the acrylic plate and the workpiece.

5. The polishing method according to claim 4, wherein the workpiece has a surface to be polished by the acrylic plate, the surface containing silicon.

6. The polishing method according to claim 4, wherein the workpiece has a surface to be polished by the acrylic plate, the surface being made of glass.
